(19) United States
(12) Patent Application Publication
(10) Pub. No.: US 2025/0365474 A1
(43) Pub. Date: Nov. 27, 2025

(54) TECHNIQUES FOR TRAINING RECOMMENDATION MODELS USING SLIDING WINDOWS

(71) Applicant: NETFLIX, INC., Los Gatos, CA (US)

(72) Inventors: Swanand Arvind JOSHI, Sunnyvale, CA (US); Yesu FENG, Foster City, CA (US); Zhe ZHANG, Mountain View, CA (US); Ko-Jen HSIAO, San Jose, CA (US); Sudarshan Dnyaneshwar LAMKHEDE, Sunnyvale, CA (US)

(21) Appl. No.: 19/046,282

(22) Filed: Feb. 5, 2025

Related U.S. Application Data
(60) Provisional application No. 63/650,791, filed on May 22, 2024.

(51) Int. Cl. H04N 21/466

(52) U.S. Cl. CPC H04N 21/4668; H04N 21/4661; H04N 21/4667

(57) ABSTRACT

Techniques for training a machine learning model to generate one or more first recommendations include generating, based on user interaction data, a plurality of fixed window samples, generating, based on the user interaction data, a plurality of sliding window samples, and performing, based on the plurality of fixed window samples and the plurality of sliding window samples, one or more training operations to generate a trained machine learning model to generate the one or more first recommendations.

### CROSS-REFERENCE TO RELATED APPLICATIONS

This application claims priority benefit of the United States Provisional Patent Application titled, “TECHNIQUES FOR TRAINING FOUNDATION MODELS USING SLIDING WINDOWS,” filed on May 22, 2024, and having Ser. No. 63/650,791. The subject matter of this related application is hereby incorporated herein by reference.

### BACKGROUND

### Technical Field

The embodiments of the present disclosure relate generally to computer science and machine learning, and more specifically, to techniques for training recommendation models using sliding windows.

### Description of the Related Art

Recommendation models are machine learning models, which are widely used in digital platforms to generate personalized recommendations by analyzing user interaction data. Recommendation models are applied in various domains, such as video streaming, e-commerce, and social media, to recommend content, products, services, and/or the like, aligned with user preferences. For example, video streaming platforms analyze user interaction data, including viewing history, genre preferences, and/or the like, to recommend movies or TV shows. E-commerce platforms use user browsing behavior, purchase history, and other user interaction data to recommend products, while social media platforms curate content feeds based on user interactions. Foundation models, which are a class of recommendation models, are designed to process large-scale user interaction data and generate representations of users and content items based on user interaction histories. The representations can be used in downstream recommendation applications, such as video and product recommendations, to enhance personalization. Foundation models often leverage pre-training on extensive user interaction data to encode patterns in user behavior, enabling a unified representation of user preferences across various contexts. Foundation models are used in recommendation systems where capturing user behavior over long periods or across various interactions is of interest.

One conventional approach for training recommendation models is based on fixed window sampling to process user interaction data. In fixed window sampling, a fixed-size window is used to select a predefined number of user interactions, such as a fixed number of the most recent user interactions. For example, a recommendation model can be trained using the 100 most recent interactions from a user's interaction history with content items. The input sequence length based on fixed window sampling remains uniform across training samples. When the fixed window is focused on recent interactions, fixed window sampling approaches are designed to prioritize short-term user behavior, which is often assumed to have the high relevance for immediate recommendations. For example, in a video streaming platform, the 100 most recent interactions from a user's viewing history, such as recently watched movies or TV shows and/or the like, can be used to train a recommendation model to recommend similar content items. In an e-commerce platform, the 50 most recent user interactions, such as product views, purchases, and/or the like, can be used to train a recommendation model to recommend related products, frequently bought items, and/or the like. In social media platforms, the user's last 200 interactions, such as likes, comments, shares, and/or the like, can be used to train a recommendation model to recommend posts, reels, accounts to follow, and/or the like.

One drawback of conventional approaches for training recommendation models based on fixed window sampling is the limited ability to capture long-term user preferences and interaction patterns. By focusing exclusively on a fixed window of user interactions, especially the most recent interactions, conventional approaches for training recommendation models often discard valuable historical user interaction data that provides insights into a user's broader interests and behavior trends over time. The truncation of user interaction history leads to suboptimal recommendations, particularly for recommendation applications where long-term user preferences play an important role in personalization. For example, a video streaming platform relying on only the most recent 100 views could miss a user's affinity for a specific genre or director evident in older interactions. Similar to a video streaming platform, an e-commerce platform that uses only the last 50 user purchases could fail to account for seasonal user purchasing habits or infrequent but significant purchases, such as high-value items. Another drawback of the conventional approaches for training recommendation models is that increasing the length of the fixed window to train recommendation models to capture long-term user preferences and intention patterns leads to larger model size, computational cost, and higher inference latency. For example, a video streaming platform aiming to include 1,000 user interactions instead of 100 user interactions in the training data could require more memory and processing power to handle the expanded input size, resulting in longer training times and slower recommendations during real-time inference.

As the foregoing illustrates, what is needed in the art are more effective techniques for training recommendation models.

### SUMMARY

One embodiment of the present disclosure sets forth a computer-implemented method for generating one or more first recommendations. The method include generating, based on user interaction data, a plurality of fixed window samples, generating, based on the user interaction data, a plurality of sliding window samples, and performing, based on the plurality of fixed window samples and the plurality of sliding window samples, one or more training operations to generate a trained machine learning model to generate the one or more first recommendations.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to prior art is that the disclosed techniques capture both short-term and long-term user preferences. Unlike conventional approaches that are based exclusively on a fixed window of recent user interactions, the disclosed techniques train a model using a broader range of user interactions resulting in a better trained model. Another technical advantage of the disclosed techniques is the ability to include long-term user preferences without increasing model size, computational cost, or inference latency. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a block diagram of a content server that can be implemented in conjunction with the network infrastructure of FIG. 1, according to various embodiments;

FIG. 3 is a block diagram of a control server that can be implemented in conjunction with the network infrastructure of FIG. 1, according to various embodiments;

FIG. 4 is a block diagram of an endpoint device that can be implemented in conjunction with the network infrastructure of FIG. 1, according to various embodiments;

FIG. 5 is a block diagram of a computer-based system according to various embodiments;

FIG. 6 is a more detailed illustration of the model trainer of FIG. 5, according to various embodiments;

FIG. 7 is a more detailed illustration of the recommendation application of FIG. 5, according to various embodiments;

FIG. 8A is a more detailed illustration of an example of fixed window samples of FIG. 6, according to various embodiments;

FIG. 8B is a more detailed illustration of an example of sliding window samples of FIG. 6, according to various embodiments;

FIG. 9 sets forth a flow diagram of method steps for training the recommendation model of FIG. 5, according to various embodiments; and

FIG. 10 sets forth a flow diagram of method steps for generating recommendations, according to various embodiments.

### DETAILED DESCRIPTION

In the following description, numerous specific details are set forth to provide a more thorough understanding of the embodiments of the present invention. However, it will be apparent to one skilled in the art that the embodiments of the present invention may be practiced without one or more of these specific details.

### System Overview

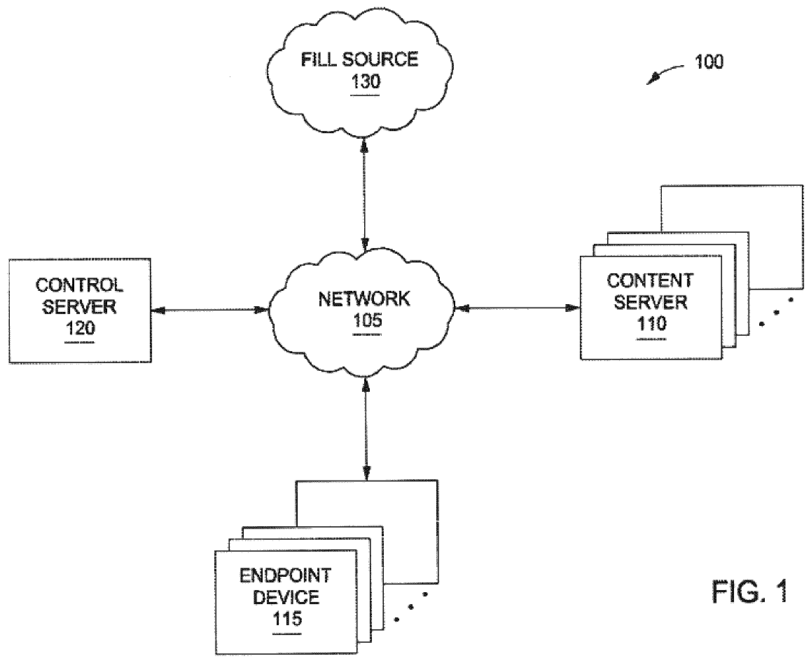

FIG. 1 illustrates a network infrastructure 100 used to distribute content to content servers 110 and endpoint devices 115, according to various embodiments of the invention. As shown, the network infrastructure 100 includes content servers 110, control server 120, and endpoint devices 115, each of which are connected via a network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, database, and server application 217 configured to communicate with the control server 120 to determine the location and availability of various files that are tracked and managed by the control server 120. Each content server 110 may further communicate with a fill source 130 and one or more other content servers 110 in order “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

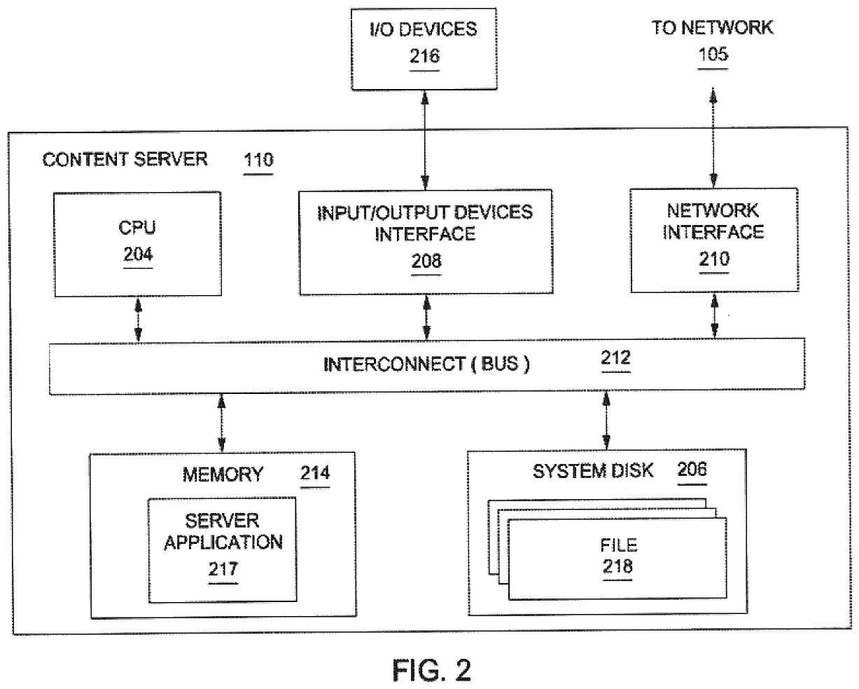

FIG. 2 is a block diagram of a content server 110 that may be implemented in conjunction with the network infrastructure 100 of FIG. 1, according to various embodiments of the present invention. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

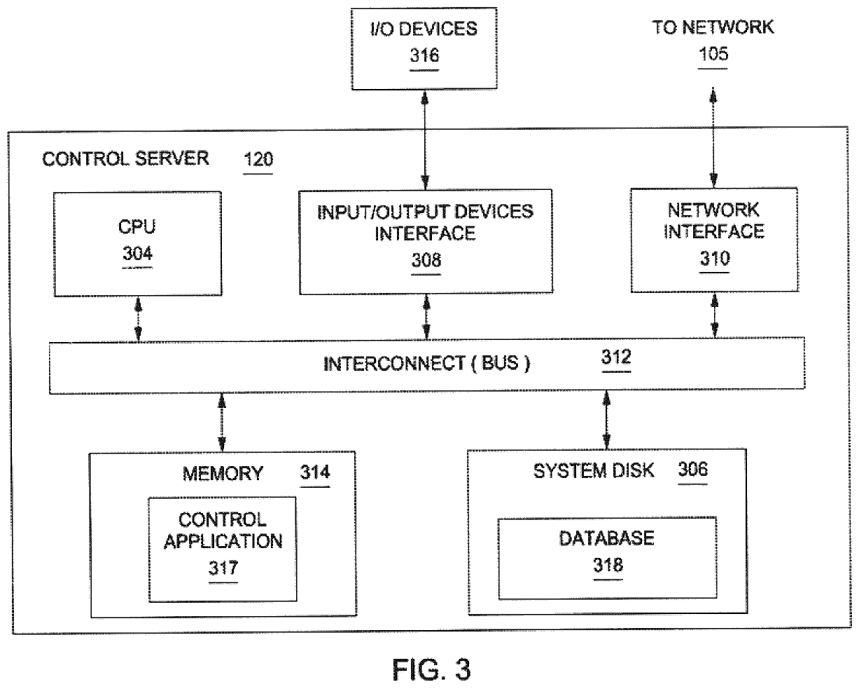

FIG. 3 is a block diagram of a control server 120 that may be implemented in conjunction with the network infrastructure 100 of FIG. 1, according to various embodiments of the present invention. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 206 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

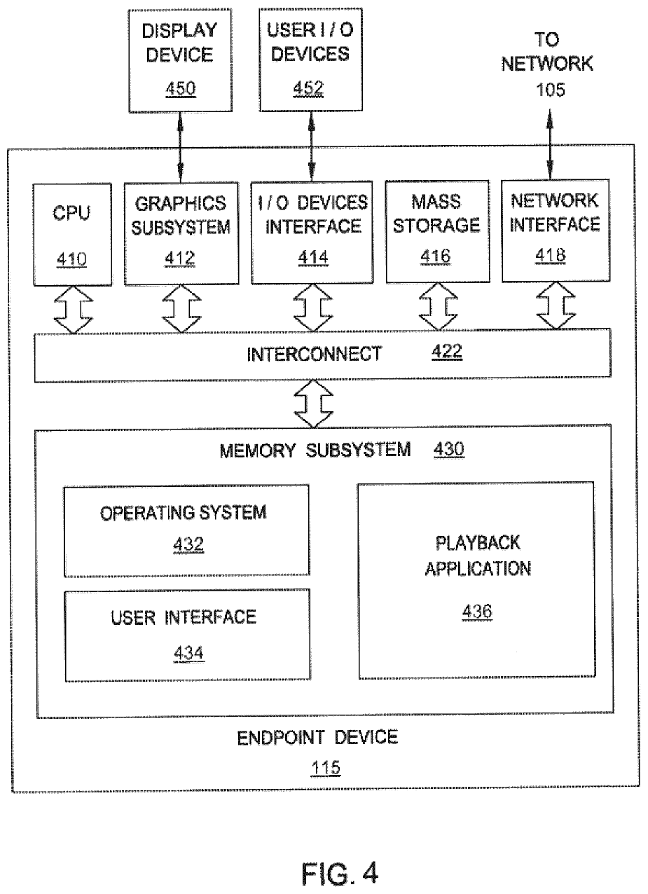

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage unit 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage unit 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage unit 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 108. Persons skilled in the art will recognize the various operating systems and user interfaces that are well-known in the art and suitable for incorporation into the endpoint device 108.

In some embodiments, the playback application 436 is configured to request and receive content from the content server 110 via the network interface 418. Further, the playback application 436 is configured to interpret the content and present the content via display device 450 and/or user I/O devices 452.

### Training Recommendation Models Based on Sliding Windows

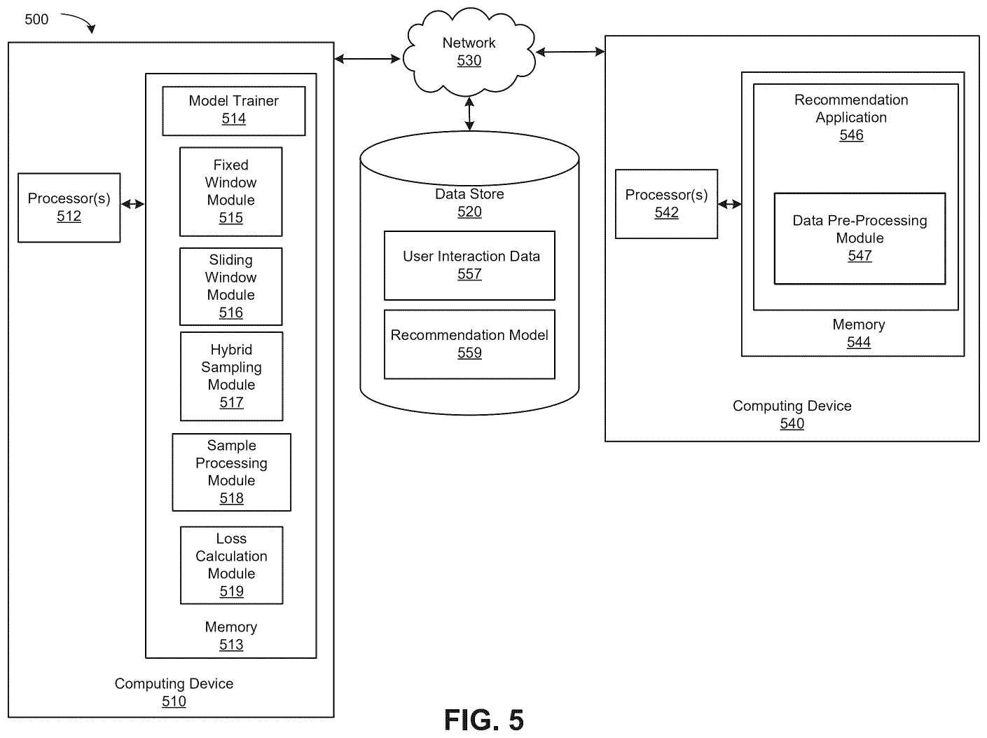

FIG. 5 is a block diagram of a computer-based system 500 according to various embodiments. As shown, the computer-based system 500 includes, without limitation, computing devices 510 and 540, a data store 520, and a network 530. Computing device 510 includes, without limitation, one or more processors 512 and memory 513. Memory 513 includes, without limitation, a model trainer 514, a fixed window module 515, a sliding window module 516, a hybrid sampling module 517, a sample processing module 518, and a loss calculation module 519. Data store 520 includes, without limitation, user interaction data 557 and a recommendation model 559. Computing device 540 includes, without limitation, one or more processors 542 and memory 544. Memory 544 includes, without limitation, a recommendation application 546. Recommendation application 546 includes, without limitation, a data pre-processing module 547. Although FIG. 5 is described in the context of recommendation systems, it is understood that the disclosed techniques are also applicable to other areas of personalization and data-driven systems, such as targeted advertising platforms, product recommendation engines, dynamic user interface customization, personalized educational content delivery, and/or the like.

Computing device 510 shown herein is for illustrative purposes only, and variations and modifications in the design and arrangement of computing device 510, without departing from the scope of the present disclosure. For example, the number of processors 512, the number of and/or type of memories 513, and/or the number of applications and or data stored in memory 513 can be modified as desired. In some embodiments, any combination of processor(s) 512 and/or memory 513 can be included in and/or replaced with any type of virtual computing system, distributed computing system, and/or cloud computing environment, such as a public, private, or a hybrid cloud system.

Each of processor(s) 512 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 512 can be any technically feasible hardware unit capable of processing data and/or executing software applications.

Memory 513 of computing device 510 stores content, such as software applications and data, for use by processor(s) 512. As shown, memory 513 includes, without limitation, a model trainer 514, a fixed window module 515, a sliding window module 516, a hybrid sampling module 517, a sample processing module 518, and a loss calculation module 519. Memory 513 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 513. The storage can include any number and type of external memories that are accessible to processor(s) 512. For example, and without limitation, the storage can include a Secure Digital Card, an external Flash memory, a portable CD-ROM, an optical storage device, a magnetic storage device, and/or any suitable combination of the foregoing.

User interaction data 557 includes detailed patterns of user behavior and activity across the recommendation platform, providing insights into what content users engage with, how the user interacts with the platform, the user preferences over time, and the contextual factors influencing user choices. In various embodiments, user interaction data 557 is split into training data, validation data, and test data across a wide range of content items. For example, user interaction data 557 can include samples from approximately 250 million users and user interactions with content items in a content library, covering thousands of distinct content items. Example interaction sequences include video plays, video likes, adding to a watchlist, and opening video details pages. The user interactions span over long periods of time ranging from weeks to months. In some embodiments, user interaction data 557 includes rich metadata and behavioral signals, such as positive interactions (e.g., what was played, added to the watchlist, watched as a teaser, and/or the like), contextual information (e.g., content never played, annotations, device used, duration of playback, number of episodes watched, and/or the like), and metadata (e.g., genre, storyline, country, title ID, and/or the like). In some embodiments, user interaction data 557 includes at least four features: interaction type, contextual cues, content metadata, and engagement metrics. For example, interaction type metadata can include distinct categories, such as teaser watched, completed playback, added to the watchlist, and/or the like, capturing various forms of user engagement indicative of session-level intent. Genre metadata can include predefined labels (e.g., comedy, thriller, drama, and/or the like), reflecting users' content preferences and helping capture implicit interest in specific types of content. Contextual cues, such as the device used, whether the content was previously interacted with, and/or the like, provide additional dimensions for understanding user preferences. Engagement metrics, such as how long a user watched a piece of content, how many episodes were completed, and/or the like, help identify patterns in user behavior that inform the recommendation system.

Fixed window module 515 processes user interaction data 557 and generates fixed window samples. In various embodiments, fixed window module 515 generates fixed window samples by selecting a predefined number of most recent user interactions from each user's interaction history included in user interaction data 557. While the fixed window could focus on the most recent user interactions, in some embodiments, fixed window module 515 can also be configured to select user interactions from specific time intervals or content categories based on predefined criteria. For example, fixed window module 515 can generate fixed window samples including the last 100 user interactions, user interactions corresponding to a specific genre, such as “comedy,” user interactions occurring within a defined time range, such as “within the last month,” and/or the like.

Sliding window module 516 processes user interaction data 557 and generates sliding window samples. In various embodiments, sliding window module 516 generates sliding window samples by iteratively selecting overlapping or contiguous portions of a user interaction history (e.g., contiguous user interactions) included in user interaction data 557 for training. Sliding window module 516 dynamically shifts the window across the user interaction history, enabling recommendation model 559 to capture both recent and historical user behaviors over multiple training epochs. For example, sliding window module 516 can generate sliding windows of 100 user interactions at a time, starting with interactions 1-100 in the first window, 101-200 in the next, and so on, or with overlapping windows such as 1-100, 50-150, and so forth. Sliding window module 516 ensures that recommendation model 559 is trained based on a broader range of user interaction sequences, including older user interaction data 557 that could reveal long-term user preferences and behavioral patterns. In various embodiments, sliding window module 516 provides flexibility in selecting user interactions to include in sliding window samples. In some examples, sliding window module 516 can prioritize interactions based on specific criteria, such as interactions from a particular time period (e.g., interactions during a special business event, seasonal interactions, and/or the like) or specific types of interactions (e.g., interactions with high engagement duration, interactions indicative of a certain intent, and/or the like). For example, sliding window module 516 could assign more importance to user interactions occurring during a major product launch, a holiday period, and/or the like. Additionally, instead of generating sliding windows as contiguous blocks, sliding window module 516 can construct samples by combining user interactions from different periods or categories to generate sliding window samples.

Hybrid sampling module 517 processes sliding window samples and fixed window samples and generates hybrid samples. In various embodiments, hybrid sampling module 517 combines a pre-defined number of recent interactions (e.g., fixed window samples) with user interactions sampled using a sliding window approach (e.g., sliding window samples) to balance the representation of short-term and long-term user behaviors in the training samples. For example, hybrid sampling module 517 could generate hybrid samples by allocating a pre-defined number of training epochs (e.g., X epochs) to focus on the latest user interactions using fixed window sampling and the remaining N-X epochs to focus on sliding window sampling that includes user interactions from a broader historical context. In some embodiments, hybrid sampling module 517 balances recent user interactions for recency-sensitive recommendations and older user interactions to capture long-term user preferences. One or more hybrid samples generated by hybrid sampling module 517 include interaction sequences spanning diverse timeframes, such as the most recent 100 user interactions included in fixed window samples and user interactions from up to 500 or 1,000 events in the historical timeline included in sliding window samples. In at least one embodiment, hybrid sampling module 517 chooses the number of sliding window samples and fixed window samples randomly. In various embodiments, hybrid sampling module 517 dynamically adjusts the number of sliding window samples and fixed window samples included in the one or more hybrid samples based on various hyperparameters, such as the number of sliding window epochs and the size of the interaction history, which can be optimized for specific user interaction datasets and recommendation objectives. For example, in a video streaming platform, hybrid sampling module 517 can combine 100 sliding window samples, which include user interactions with genres like “comedy” or “thriller” over the past year, and 50 fixed window samples, which include the last 100 user interactions from the current month to account for trending content. Similarly, for an e-commerce platform, hybrid sampling module 517 can combine 100 sliding window samples, which include high-value purchases or seasonal buying patterns from previous years, and 120 fixed window samples, which include the latest browsing and purchasing activity during a sale event.

Sample processing module 518 processes hybrid samples and generates processed samples. In various embodiments, sample processing module 518 tokenizes hybrid samples by converting hybrid samples into a sequence of discrete tokens that represent various user interaction types, metadata, and contextual features. In some embodiments, the tokens are then processed using an embedding table, which maps each token to a dense vector representation. The embedding table captures the semantic relationships between tokens, such as the similarity between genres, interaction types, or user behaviors. In at least one embodiment, tokens corresponding to user interactions, such as “video played,” “added to watchlist,” “liked,” and/or the like, are mapped to specific embeddings that encode token relevance and relationships. For example, the token “liked” could have an embedding that is closer in vector space to “added to watchlist” than to “opened details page,” reflecting semantic similarity in user engagement patterns. Similar to user interaction tokens, metadata tokens such as “genre: comedy,” “device: mobile,” “duration: long,” and/or the like, are converted into embeddings that provide additional contextual information. For example, “genre: comedy” and “genre: thriller” could have embeddings that are closer to one another than to “genre: documentary,” capturing user preferences for entertainment content versus informational content. Processed samples include one or more embeddings that can be processed by recommendation model 559.

Loss calculation module 519 processes one or more recommendations and one or more ground truth recommendations included in user interaction data 557 and generates a loss. In various embodiments, loss calculation module 519 compares the predicted recommendations generated by recommendation model 559 and the ground truth labels included in user interaction data 557 and calculates a loss. In some examples, loss calculation module 519 uses a cross-entropy loss function to calculate the loss. The ground truth labels (e.g., ground truth recommendations) can include metadata, such as user interaction type, content genre, user engagement metrics, and/or the like, which provide supervision signals for training recommendation model 559.

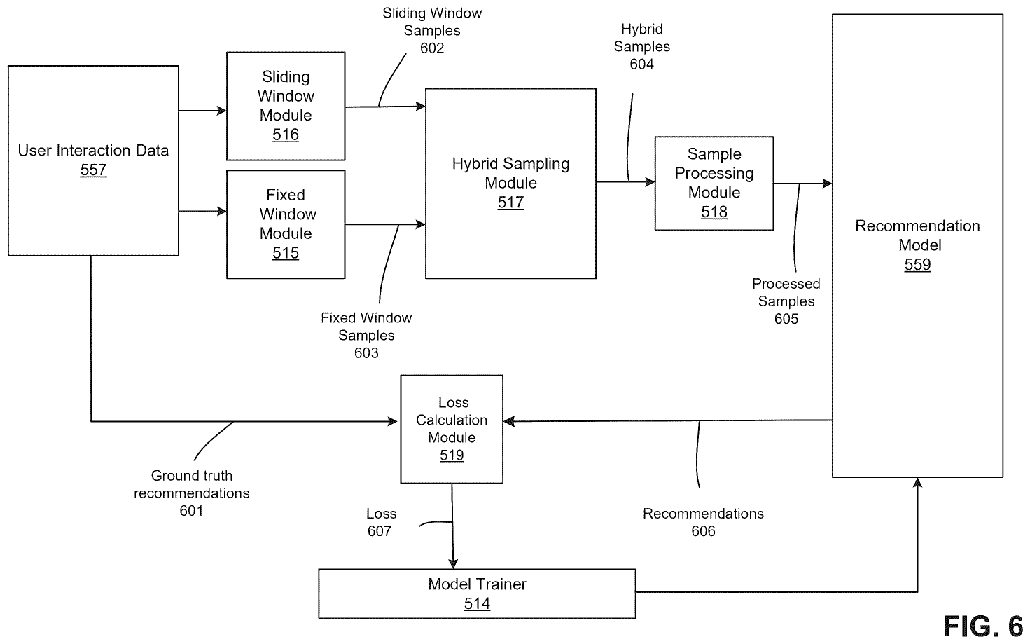

Model trainer 514 trains recommendation model 559 using the loss. In various embodiments, model trainer 514 optimizes the parameters of recommendation model 559 through iterative training cycles, such as using adaptive moment estimation (Adam) algorithm. In various embodiments, model trainer 514 applies techniques such as cross-validation, early stopping, and hyperparameter optimization to improve training performance and prevent overfitting. Model trainer 514 is described in more detail in conjunction with FIG. 6.

Data store 520 can include any storage device or devices, such as fixed disc drive(s), flash drive(s), optical storage, network attached storage (NAS), and/or a storage area-network (SAN). Although shown as accessible over network 530, in some embodiments computing device 510 can include data store 520. As shown, data store 520 is storing, without limitation, user interaction data 557 and recommendation model 559.

Recommendation model 559 is a machine learning model, which processes one or more processed samples and generates recommendations. In various embodiments, recommendation model 559 can be implemented as an autoregressive model, a deep neural network, a foundation model, and/or the like. In some embodiments, the input layer of recommendation model 559 corresponds to the input size of recommendation model 559, which matches the size of the processed samples generated by sample processing module 518. For example, if processed samples include embeddings derived from 100 user interactions, the input layer of recommendation model 559 can be designed to accommodate the input size. In some examples, recommendation model 559 includes multiple hidden layers, such as fully connected layers, convolutional layers, attention mechanisms, transformer-based architectures, and/or the like. For example, in an autoregressive implementation, recommendation model 559 predicts the user next interaction in a user's interaction sequence based on prior user interactions, processing the input embeddings (e.g., processed samples) iteratively. In a deep neural network implementation, recommendation model 559 processes the sequence of input embeddings simultaneously, capturing both local and global patterns in user interaction data 557. In a foundation model implementation, recommendation model 559 uses large-scale pretraining on user interaction data 557 to generate recommendations, enabling recommendation model 559 to generalize across diverse user behaviors and content categories.

Network 530 can be a wide area network (WAN), such as the Internet, a local area network (LAN), a cellular network, and/or any other suitable network. Computing devices 510 and 540 and data store 520 are in communication over network 530. For example, network 530 can include any technically feasible network hardware suitable for allowing two or more computing devices to communicate with each other and/or to access distributed or remote data storage devices, such as data store 520.

Computing device 540 shown herein is for illustrative purposes only, and variations and modifications in the design and arrangement of computing device 540, without departing from the scope of the present disclosure. For example, the number of processors 542, the number of and/or type of memories 544, and/or the number of applications and or data stored in memory 544 can be modified as desired. In some embodiments, any combination of processor(s) 542 and/or memory 544 can be included in and/or replaced with any type of virtual computing system, distributed computing system, and/or cloud computing environment, such as a public, private, or a hybrid cloud system.

Each of processor(s) 542 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 542 can be any technically feasible hardware unit capable of processing data and/or executing software applications. During operation, processor(s) 542 can receive user inputs and context inputs from input devices (not shown), such as a keyboard or a mouse.

Memory 544 of computing device 540 stores content, such as software applications and data, for use by processor(s) 542. As shown, memory 544 includes, without limitation, a recommendation application 546. Memory 544 can be any type of memory capable of storing data and software applications, such as RAM, ROM, EPROM or Flash ROM, or any suitable combination of the foregoing. In some embodiments, additional storage (not shown) can supplement or replace memory 544. The storage can include any number and type of external memories that are accessible to processor(s) 542. For example, and without limitation, the storage can include a Secure Digital Card, an external Flash memory, a portable CD-ROM, an optical storage device, a magnetic storage device, and/or any suitable combination of the foregoing.

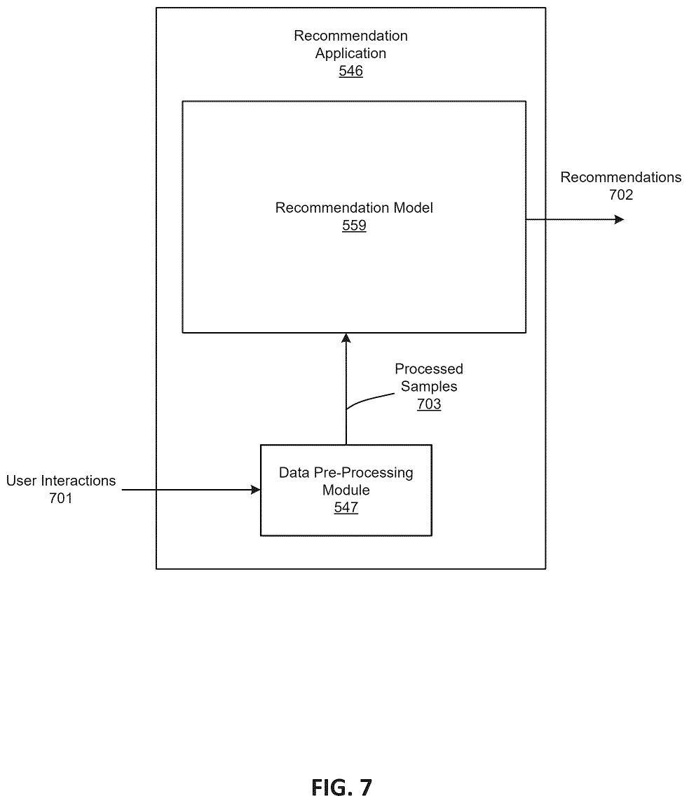

Recommendation application 546 processes user interactions and generates recommendations. In various embodiments, recommendation application 546 receives user interactions through various I/O devices (not shown), including but not limited to direct interactions, browsing activity, and implicit feedback, such as engagement duration, skipped items, and/or the like. As shown, recommendation application 546 includes, without limitation, a data pre-processing module 547. Data pre-processing module 547 processes user interactions and generates one or more processed samples. The one or more processed samples includes one or more embeddings based on user interaction types and contextual information included in user interactions. For example, embeddings can be generated from user interaction types, such as “played a video,” “added to watchlist,” “liked a teaser,” “opened the details page,” and/or the like. In various embodiments, data pre-processing module 547 maps each of the user interaction types to a dense vector that encodes the relevance and relationship to other user interactions. Data pre-processing module 547 can also generate one or more embeddings from contextual information included in user interactions, such as “device type” (e.g., “mobile” or “desktop”), “duration of playback” (e.g., partial watch vs. full watch), and “number of episodes watched” (e.g., single episode vs. binge-watching). In various embodiments, recommendation application 546 uses the trained recommendation model 559 to process one or more processed samples and generate recommendations. Recommendation application 546 is described in more detail in conjunction with FIG. 7.

### Model Trainer

FIG. 6 is a more detailed illustration of the model trainer 514, according to various embodiments. As shown, model trainer 514 uses loss 607 to train recommendation model 559. Sliding window module 516 processes user interaction data 557 to generate sliding window samples 602. Fixed window module 515 processes user interaction data 557 to generate fixed window samples 603. Hybrid sampling module 517 processes sliding window samples 602 and fixed window samples 603 to generate hybrid samples 604. Sample processing module 518 processes hybrid samples 604 to generate processed samples 605. Recommendation model 559 processes one or more processed samples 605 to generate recommendations 606. Loss calculation module 519 processes recommendations 606 and ground truth recommendations 601 included in user interaction data 557 to generate loss 607, which is used by model trainer 514 to train recommendation model 559.

In operation, fixed window module 515 process user interaction data 557 and generates fixed window samples 603. In various embodiments, fixed window module 515 generates fixed window samples 603 by selecting a predefined number of user interactions from each user's interaction history included in user interaction data 557. In some embodiments, fixed window module 515 is configured to select user interactions based on specific time intervals, content categories, or other predefined criteria. For example, fixed window module 515 can generate fixed window samples 603 that include the last 100 user interactions to capture the user's recent activity. Alternatively, fixed window module 515 can generate fixed window samples 603 based on user interactions with a particular content genre, such as “comedy” or “thriller,” to analyze user preferences within the genres. In some embodiments, fixed window module 515 generates fixed window samples 603 based on user interactions occurring during a specific time frame, such as “interactions from the last month” or “interactions from a specific holiday season,” to account for temporal patterns in user behavior. Additionally, fixed window samples 603 include user interactions with specific engagement types, such as “added to watchlist,” “completed playback,” “watched teaser,” and/or the like, to emphasize user interactions indicative of strong user intent. For example, fixed window samples 603 could include user interactions from a user's engagement with premium content, such as critically acclaimed movies, exclusive releases, and/or the like, to highlight preferences for high-value items on a recommendation platform.

Sliding window module 516 processes user interaction data 557 and generates sliding window samples 602. In various embodiments, sliding window module 516 generates sliding window samples 602 by iteratively selecting overlapping or contiguous portions of a user interaction history included in user interaction data 557. Sliding window module 516 dynamically shifts various sliding windows across the user interaction history. For example, sliding window module 516 can generate sliding windows of 100 user interactions at a time, starting with interactions 1-100 in the first window, 101-200 in the next, and so on, or with overlapping windows such as 1-100, 50-150, and so forth. The sliding window ensures that recommendation model 559 is trained on a broader range of user interaction sequences, including older user interaction data 557 that could reveal long-term user preferences and behavioral patterns. In various embodiments, sliding window module 516 provides flexibility in selecting user interactions to include in sliding window samples 602. For example, sliding window samples 602 can prioritize user interactions from a specific time period, such as “interactions during the last holiday season”, “interactions occurring during a major product launch,” and/or the like Alternatively, sliding window module 516 can prioritize user interactions with high engagement durations (e.g., full playback or binge-watching sessions) or user interactions that are indicative of specific user intent (e.g., “added to watchlist,” “rated 5 stars,” or “shared with friends”). In various embodiments, sliding window module 516 is also configured to construct sliding windows using user interactions from various categories or periods. For example, sliding window samples 602 could include user interactions with specific genres, such as “thriller” and “comedy,” or group user interactions with various content types, such as “movies” and “TV series.” In at least one embodiment, sliding window module 516 generates sliding window samples 602 that include user interactions with high-value content (e.g., critically acclaimed titles) and user interactions including but not limited to lower engagement content (e.g., teasers or previews) to capture a more comprehensive picture of user preferences. In some embodiments, sliding window module 516 adjusts the sampling technique based on specific business objectives or recommendation tasks. For example, during a promotional event, sliding window module 515 could focus on user interactions which include newly released content items or featured products, ensuring that recommendation model 559 is trained on user interactions aligned with current trends.

Hybrid sampling module 517 processes sliding window samples 602 and fixed window samples 603 and generates hybrid samples 604. In various embodiments, hybrid sampling module 517 combines a pre-defined number of fixed window samples 603 with a pre-defined number of sliding window samples 602 to balance the representation of short-term and long-term user behaviors in the training samples. For example, hybrid sampling module 517 can generate hybrid samples 604 by allocating a pre-defined number of training epochs (e.g., 5 epochs) to focus on the latest user interactions using fixed window sampling and the remaining 10 epochs to focus on sliding window sampling that includes user interactions from a broader historical context. Hybrid samples 604 include user interaction sequences spanning various timeframes. For example, hybrid samples 604 can include the most recent 100 user interactions included in fixed window samples 603 and user interactions from up to 500 or 1,000 events in the historical timeline included in sliding window samples 602. In at least one embodiment, hybrid sampling module 517 chooses the number of sliding window samples 602 and fixed window samples 603 randomly to introduce variability in the training data and reduce overfitting. In some embodiments, hybrid sampling module 517 dynamically adjusts the number of sliding window samples 602 and fixed window samples 603 based on hyperparameters, such as the number of sliding window epochs and the size of the user interaction history, which can be optimized for specific user interaction data 557 and recommendation objectives. For example, in a video streaming platform, Hybrid sampling module 517 can combine 100 sliding window samples 602, which include user interactions with genres like “comedy” or “thriller” over the past year, and 50 fixed window samples 603, which include the last 100 user interactions from the current month to account for trending content. Similarly, for an e-commerce platform, hybrid sampling module 517 can combine 120 sliding window samples 602, which include high-value purchases or seasonal buying patterns from previous years, and 80 fixed window samples 603, which include the latest browsing and purchasing activity during a sale event. In a social media platform, hybrid sampling module 517 could combine 70 sliding window samples 602 capturing user interactions with posts, reels, and videos over the past six months and 30 fixed window samples 603 capturing the last 50 likes and comments made in the past week to prioritize recency-sensitive engagement. In some embodiments, hybrid sampling module 517 also includes interactions with specific content categories, user cohorts, or business priorities. For example, hybrid samples 604 could prioritize sliding window samples 602 of user interactions with premium content or exclusive releases and fixed window samples 603 of user interactions with highly engaging trending content.

Sample processing module 518 processes hybrid samples 604 and generates processed samples 605. In various embodiments, sample processing module 518 tokenizes hybrid samples 604 by converting the hybrid samples 604 into a sequence of discrete tokens representing various user interaction types, metadata, and contextual features. The tokens capture various aspects of user behavior and interaction history. For example, tokens can represent actions such as “video played,” “added to watchlist,” “liked,” or “opened details page,” as well as contextual information such as “device type: mobile,” “genre: thriller,” or “engagement duration: long.” In some embodiments, sample processing module 518 processes the tokens using an embedding table, which maps each token to a dense vector representation that captures semantic relationships between the tokens. For example, the token “liked” can have an embedding closer in vector space to “added to watchlist” than to “opened details page,” reflecting the similarity in user engagement patterns. Metadata tokens such as “genre: comedy” and “genre: thriller” can have embeddings that are closer to one another than to “genre: documentary,” reflecting a user preference for entertainment-focused genres over informational genres. Processed samples 605 include one or more embeddings that capture the relationships and nuances in user behavior. For example, hybrid samples 604 combining sliding window samples 602 of user interactions with “comedy” and “thriller” genres over the past year and fixed window samples 603 of recent user interactions, such as “played a video” on a “desktop device,” could result in embeddings for “genre: comedy,” “genre: thriller,” “action: played,” and “device type: desktop.” In some embodiments, sample processing module 518 generates embeddings for higher-order features, such as aggregated user interaction patterns. For example, the tokens for “binge-watched” or “frequently added to watchlist” could be mapped to embeddings that represent repeated behaviors across various sessions. Embeddings could also encode relationships between content types, such as “TV series” being closer to “episodic content” than to “movies,” or between engagement types, such as “rated 5 stars” being closer to “completed playback” than to “skipped.”

Recommendation model 559 processes one or more processed samples 605 and generates recommendations 606. In various embodiments, recommendation model 559 is a machine learning model that can be implemented as an autoregressive model, a deep neural network, a foundation model, and/or the like. In various embodiments, the size of user interaction data 557 is greater than the input size of recommendation model 559. In some embodiments, the input layer of recommendation model 559 corresponds to the input size of recommendation model 559, which matches the size of the processed samples 605 generated by sample processing module 518. For example, if processed samples 605 include embeddings derived from 100 user interactions, the input layer of recommendation model 559 is designed to accommodate the input size of 100. In some examples, recommendation model 559 has an input sequence limit of 100 items (e.g., context window size) to satisfy online serving latency requirements for real-time recommendations. In various embodiments, recommendation model 559 includes multiple hidden layers, such as fully connected layers, convolutional layers, attention mechanisms, transformer-based architectures, and/or the like. For example, in an autoregressive implementation, recommendation model 559 predicts the next user interaction in a sequence based on prior user interactions, processing input embeddings (e.g., processed samples 605) iteratively. The autoregressive implementation is useful for recommendation tasks, such as predicting the next video a user might watch, the next product a user might browse, and/or the like. In a deep neural network implementation, recommendation model 559 processes the entire sequence of input embeddings simultaneously, capturing both local patterns (e.g., interactions within a single session) and global patterns (e.g., long-term preferences across multiple sessions). The deep neural network implementation could be used in recommendation tasks, such as generating a ranked list of recommendations tailored to a user's overall preferences. In a foundation model implementation, recommendation model 559 leverages large-scale pretraining on user interaction data 557 to generate recommendations 606, enabling recommendation model 559 to generalize across various user behaviors and content categories. For example, the foundation model could use embeddings pre-trained on user interactions from millions of users to recommend content items in niche categories or to personalize recommendations for new users with limited interaction history. The foundation model implementation is useful for recommendation tasks, such as cross-platform recommendations, where user behavior varies across various services on the recommendation platform. In some embodiments, recommendation model 559 is optimized for specific use cases. For example, in a video streaming platform, recommendation model 559 can generate recommendations 606 by analyzing embeddings for recent “watched” interactions, combined with metadata such as “genre: comedy” or “duration: long.” In an e-commerce platform, recommendation model 559 can predict products to recommend by processing embeddings for recent purchases or browsing history, alongside contextual features such as “holiday season” or “discounted items.” In a social media application, recommendation model 559 can use embeddings derived from recent “liked” or “commented” interactions, combined with metadata such as “post type: video” or “user cohort: influencers.”

Loss calculation module 519 processes recommendations 606 and ground truth recommendations 601 and generates loss 607. In various embodiments, loss calculation module 519 compares the predicted recommendations 606 generated by recommendation model 559 with the ground truth recommendations 601 included in user interaction data 557 and calculates loss 607. Loss 607 serves as a supervision signal for training recommendation model 559. For example, loss calculation module 519 could use a cross-entropy loss function to measure the difference between the predicted probability distribution included in recommendations 606 and the actual ground truth labels included in ground truth recommendations 601. Ground truth recommendations 601 can include various types of metadata that provide additional context and supervision signals for model training. For example, metadata could include user interaction types (e.g., “liked,” “added to watchlist”), content attributes (e.g., “genre: comedy,” “duration: long”), and user engagement metrics (e.g., “watched 80% of the video,” “binge-watched three episodes”). For example, if recommendation model 559 predicts that a user would “like” a particular movie, but the ground truth indicates that the user “added it to their watchlist,” loss calculation module 519 computes the difference and generates loss 607 based on the difference. In some embodiments, loss calculation module 519 calculates separate losses included in loss 607 for various aspects of the recommendation task. For example, one loss could evaluate the accuracy of content genre predictions, while another loss evaluates the ranking of recommended content items based on user engagement likelihood. The losses can then be aggregated into a composite loss 607 that balances various objectives, such as relevance, diversity, and engagement prediction accuracy. For example, in a video streaming platform, loss calculation module 519 can compute loss 607 based on how well the predicted recommendations align with the user's “liked” or “watched” content history. In an e-commerce platform, loss 607 could be based on predictions of seasonal purchasing patterns or high-value purchases. In various embodiments, loss calculation module 519 uses loss functions tailored to specific business objectives to generate loss 607. For example, margin-based losses can be used to improve the ranking of high-value recommendations 606, while attention-weighted losses can be used for predictions concerning user interactions with longer engagement durations or higher user intent.

Model trainer 514 uses loss 607 to train recommendation model 559. In various embodiments, model trainer 514 optimizes the parameters of recommendation model 559 through iterative training cycles using optimization algorithms such as Adam, stochastic gradient descent (SGD), root mean square propagation (RMSProp), and/or the like. During each training iteration, model trainer 514 processes loss 607 and updates the parameters of recommendation model 559 to minimize loss 607. In some embodiments, model trainer 514 includes techniques, such as cross-validation and/or the like, to validate model performance on the validation dataset included in user interaction data 557, ensuring that recommendation model 559 generalizes well to unseen data. In some embodiments, model trainer 514 uses early stopping to halt training when performance on the validation dataset stops improving, preventing overfitting. In at least one embodiment, model trainer 514 uses hyperparameter optimization, such as tuning the learning rate, batch size, or dropout rate, to further refine the training process and improve model performance. In some embodiments, model trainer 514 performs the training iteratively to focus on various aspects of recommendation model 559. For example, model trainer 514 can first train recommendation model 559 on fixed window samples 603 to capture short-term user behaviors and then fine-tune recommendation model 559 using sliding window samples 602 to include long-term preferences. In some embodiments, model trainer 514 uses separate loss functions optimized in sequence, such as first minimizing genre prediction loss and then optimizing ranking loss for recommended items. For example, in a video streaming platform, the iterative training process can include optimizing parameters to recommend trending content based on recent user interactions while ensuring that historical user preferences, such as a liking for “thriller” movies, are also captured. In an e-commerce platform, model trainer 514 could prioritize training on high-value purchases or seasonal patterns during early epochs and fine-tune on real-time browsing data in later epochs. In various embodiments, model trainer 514 trains recommendation model 559 iteratively until a stopping criterion is met, such as reaching a maximum number of iterations, a plateauing loss function, and/or the like. In various embodiments, once the training of recommendation model 559 is complete, model trainer 514 stores recommendation model 559 in data store 520, or elsewhere.

### Recommendations Using the Trained Model

FIG. 7 is a more detailed illustration of the recommendation application, according to various embodiments. As shown, recommendation application 546 includes, without limitation, data pre-processing module 547 and recommendation model 559. In various embodiments, recommendation application 546 processes one or more user interactions 701 and generates one or more recommendations 702 using the trained recommendation model 559. In various embodiments, recommendation application 546 receives user interactions 701 through various I/O devices (not shown), including but not limited to direct interactions, browsing activity, and implicit feedback, such as engagement duration, skipped items, and/or the like.

Data pre-processing module 547 processes one or more user interactions 701 and generates one or more processed samples 703. The one or more processed samples 703 include one or more embeddings based on user interaction types and contextual information included in user interactions 701. For example, data pre-processing module 547 can generate embeddings from user interaction types, such as “played a video,” “added to watchlist,” “liked a teaser,” “opened the details page,” “shared a video,” and/or the like. Each user interaction type is mapped to a dense vector that encodes the relevance and semantic relationship to other user interaction types. For example, the embedding for “added to watchlist” could be closer in vector space to “liked a teaser” than to “shared a video,” reflecting the similarity in user engagement patterns. In addition to user interaction types, data pre-processing module 547 generates embeddings based on contextual information included in user interactions 701. For example, contextual embeddings can represent “device type” (e.g., “mobile,” “desktop,” or “smart TV”), “duration of playback” (e.g., partial watch vs. full watch), “time of interaction” (e.g., morning, afternoon, or evening), or “number of episodes watched” (e.g., single episode vs. binge-watching). The contextual embeddings provide additional dimensions to the processed samples 703, capturing nuances of user behavior and preferences. For example, a user interaction 701 where a “thriller movie” was “played on a mobile device” at “8 PM” and watched for “10 minutes” could result in embeddings for “interaction type: played,” “device type: mobile,” “time of interaction: evening,” and “duration: partial watch.” In some embodiments, data pre-processing module 547 generates processed samples 703, which include embeddings for aggregated behaviors and metadata. For example, embeddings could represent “user preference for specific genres” (e.g., “comedy” and “thriller”), “average session length” (e.g., 30 minutes), or “frequency of certain interactions” (e.g., “watched trailers 3 times this week”). Additionally, data pre-processing module 547 could generate embeddings for specific content metadata, such as “genre: romance,” “language: English,” “country: USA,” or “content type: TV series.” The one or more processed samples 703 are then processed by the trained recommendation model 559 to generate personalized recommendations 702 based on the user's behavior and preferences. For example, a processed sample combining “played thriller movies on a mobile device in the evening” and “added a comedy movie to the watchlist” could lead the recommendation model 559 to recommend similar thriller or comedy movies for evening viewing. In various embodiments, recommendations 702 include a ranked list of content items from a content catalog, tailored to the user's preferences and interaction history. For example, in a video streaming platform, recommendations 702 can include suggested movies, TV shows, or documentaries, prioritized based on genres or themes the user has shown interest in, such as “comedy” or “thriller.” In an e-commerce setting, recommendations 702 can include products the user is likely to purchase, such as electronics, clothing, or recently discounted items, ranked based on relevance and purchase likelihood. Additionally, recommendations 702 could provide personalized playlists, curated collections (e.g., “Top Picks for You”), or real-time recommendations for a user, such as trending content or seasonal offers.

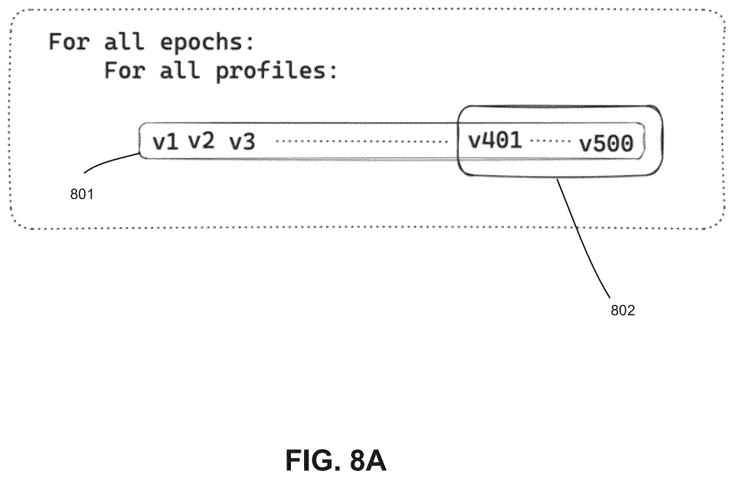

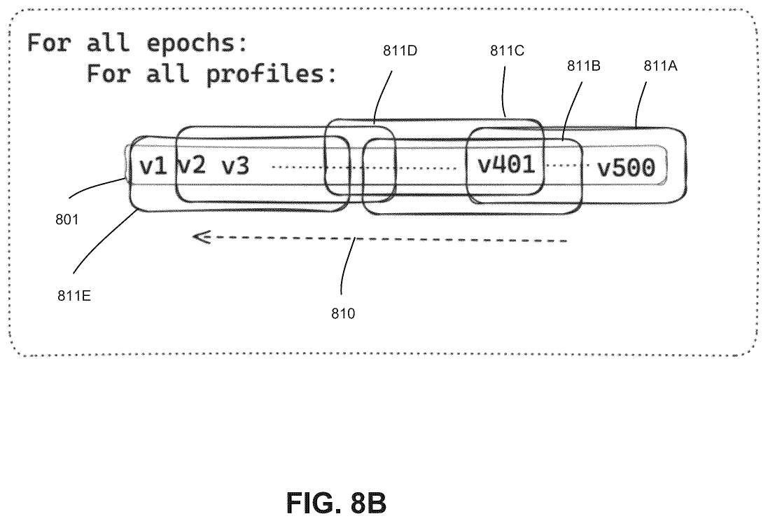

FIG. 8A is a more detailed illustration of an example of fixed window samples 603, according to various embodiments. As shown, user interaction data 557 includes, without limitation, a sequence of user interactions 801, representing the complete history of interactions for a user. The user interactions 801 can include actions such as “played a video,” “added to watchlist,” “liked a teaser,” “opened the details page,” and/or other similar user interactions. Each interaction in the sequence of user interactions 801 can also include metadata such as content genre, device type, playback duration, timestamp, and/or the like. From the sequence of user interactions 801, fixed window module 515 selects a subset of the sequence of user interactions 801 based on a fixed window size, which defines the range of recent user interactions used for training of recommendation model 559. For example, in FIG. 8A, fixed window 802 represents the last 100 interactions from the user's interaction history, ranging from v401 to v500. The selection allows fixed window module 515 to prioritize short-term user behaviors, which are often important for immediate recommendations or session-specific intent predictions. Fixed window samples 603 are generated for all profiles and across all training epochs, ensuring consistent training data is provided for training recommendation model 559.

FIG. 8B is a more detailed illustration of an example of sliding window samples 602, according to various embodiments. As shown, user interaction data 557 includes, without limitation, a sequence of user interactions 801, representing the complete history of user interactions. Sliding window module 516 processes the sequence iteratively, by overlapping or contiguous sliding over the sequence of user interactions 801. Each sliding window 811A-811E represents a subset of the sequence of user interactions 801, capturing a portion of the user's interaction history for training or inference. For example, in FIG. 8B, each of sliding windows 811A-811E include a fixed number of user interactions (e.g., 100), dynamically shifted across the sequence of user interactions 801 as shown by arrow 810. Sliding window 811A starts with the last 100 interactions from v401 to v500, while the sliding window 811B overlaps partially with 811A, covering a range, such as v351 to v450, and so on. The iterative shifting as shown by arrow 810 allows sliding window module 516 to include both recent and historical user interactions, enabling recommendation model 559 to learn patterns from different parts of the user's interaction history. In some embodiments, sliding windows 811A-811E can be configured to prioritize specific criteria, such as focusing on high-engagement interactions, interactions during a specific timeframe, or interactions with particular content types (e.g., “thriller movies” or “premium content”). For example, sliding window 811E could include user interactions during a holiday season, while 811C could include user interactions with content in a specific genre, such as “comedy.” By including diverse interaction segments, sliding window samples 602 ensure that recommendation model 559 is trained on both short-term behaviors and long-term preferences.

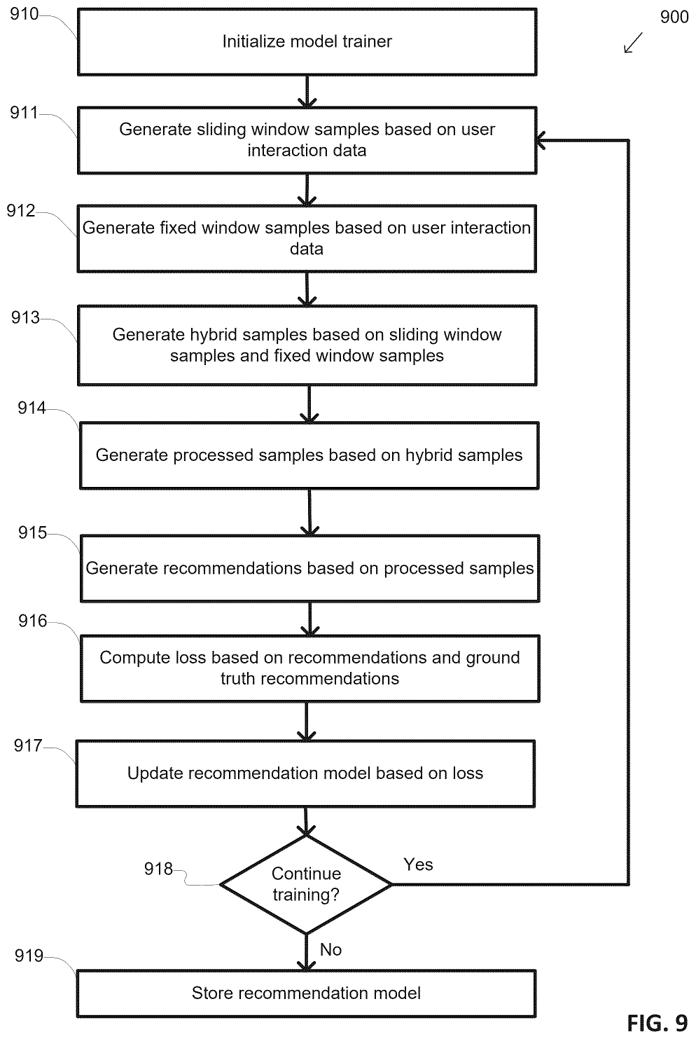

FIG. 9 sets forth a flow diagram of method steps for training recommendation model 559, according to various embodiments. Although the method steps are described in conjunction with the systems of FIGS. 1-6 and the examples of FIGS. 8A-8B, persons skilled in the art will understand that any system configured to perform the method steps in any order falls within the scope of the present disclosure.

The method 900 begins with step 910, wherein model trainer 514 is initialized. In some embodiments, the initialization includes setting the values for various parameters for training recommendation model 559. The parameters include the learning rate, which determines the step size for updating weights of recommendation model 559 during optimization by model trainer 514, and the optimizer configuration, such as selecting an algorithm, such as Adam, RMSProp, or SGD. Initialization also includes setting the batch size, which specifies the number of processed samples 605 to be included in each training epoch, and the maximum number of epochs. In various embodiments, one or more hyperparameters for recommendation model 559, such as the number of layers, hidden units per layer, dropout rate, and/or the like are initialized to control the architecture and regularization of recommendation model 559. Whenever recommendation model 559 is an autoregressive model, deep neural networks, or foundation models, initialization also includes configuring model-specific parameters, such as the context window size (e.g., 100 interactions) for autoregressive models or preloading pretrained weights for foundation models. In some embodiments, model trainer 514 also initializes the data processing pipeline, including the size of fixed window samples 603 and the size of sliding window samples 602. In at least one embodiment, model trainer 514 sets one or more parameters, such as window sizes, overlap percentages, and the number of epochs allocated for each sample type. For example, sliding window configurations could define a window size of 100 interactions with a 50% overlap, while hybrid sampling module 517 could allocate five epochs to fixed window samples 603 and 10 epochs to sliding window samples 602. In some embodiments, model trainer 514 sets one or more evaluation parameters, such as the validation split, early stopping criteria, and performance metrics (e.g., accuracy, mean reciprocal rank).

At step 911, sliding window module 516 generates sliding window samples 602 based on user interaction data 557. In various embodiments, sliding window module 516 generates sliding window samples 602 by iteratively selecting overlapping portions of a user interaction history included in user interaction data 557. Sliding window module 516 dynamically shifts various sliding windows across the user interaction history. In various embodiments, sliding window module 516 provides flexibility in selecting user interactions to include in sliding window samples 602, such as prioritizing user interactions from a specific time period, prioritizing user interactions with high engagement durations, and/or prioritizing user interactions that are indicative of specific user intent. In various embodiments, sliding window module 516 is also configured to construct sliding windows using user interactions from various categories or periods. In at least one embodiment, sliding window module 516 generates sliding window samples 602 that include user interactions with high-value content and user interactions including but not limited to lower engagement content. In some embodiments, sliding window module 516 adjusts the sampling technique based on specific business objectives or recommendation tasks.

At step 912, fixed window module 515 generates fixed window samples 603 based on user interaction data 557. In various embodiments, fixed window module 515 generates fixed window samples 603 by selecting a predefined number of user interactions from each user's interaction history included in user interaction data 557. In some embodiments, fixed window module 515 is configured to select user interactions based on specific time intervals, content categories, or other predefined criteria. Alternatively, fixed window module 515 can generate fixed window samples 603 based on user interactions with a particular content genre. In some embodiments, fixed window module 515 generates fixed window samples 603 based on user interactions occurring during a specific time frame.

At step 913, hybrid sampling module 517 generates hybrid samples 604 based on sliding window samples 602 and fixed window samples 603. In various embodiments, hybrid sampling module 517 combines a pre-defined number of fixed window samples 603 with a pre-defined number of sliding window samples 602 to balance the representation of short-term and long-term user behaviors in the training samples. In at least one embodiment, hybrid sampling module 517 chooses the number of sliding window samples 602 and fixed window samples 603 randomly to introduce variability in the training data and reduce overfitting. In some embodiments, hybrid sampling module 517 dynamically adjusts the number of sliding window samples 602 and fixed window samples 603 based on hyperparameters, such as the number of sliding window epochs and the size of the user interaction history, which can be optimized for specific user interaction data 557 and recommendation objectives. In some embodiments, hybrid sampling module 517 also includes user interactions with specific content categories, user cohorts, or business priorities.

At step 914, sample processing module 518 generates processed samples 605 based on hybrid samples 604. In various embodiments, sample processing module 518 tokenizes hybrid samples 604 by converting the hybrid samples 604 into a sequence of discrete tokens representing various user interaction types, metadata, and contextual features. In some embodiments, sample processing module 518 processes the tokens using an embedding table, which maps each token to a dense vector representation that captures semantic relationships between the tokens. In some embodiments, sample processing module 518 generates embeddings for higher-order features, such as aggregated user interaction patterns.

At step 915, recommendation model 559 generates recommendations 606 based on processed samples 605. Whenever recommendation model 559 is an autoregressive model, recommendation model 559 predicts the next user interaction in a sequence based on prior user interactions, processing input embeddings (e.g., processed samples 605) iteratively. Whenever recommendation model 559 is a deep neural network, recommendation model 559 processes the entire sequence of input embeddings simultaneously, capturing both local patterns and global patterns. Whenever recommendation model 559 is a foundation model, recommendation model 559 uses large-scale pretraining on user interaction data 557 to generate recommendations 606, enabling recommendation model 559 to generalize across various user behaviors and content categories. In some embodiments, recommendation model 559 is optimized for specific use cases, such as video streaming, e-commerce platforms, and social media applications.

At step 916, loss calculation module 519 computes loss 607 based on recommendations 606 and ground truth recommendations 601. In various embodiments, loss calculation module 519 compares the predicted recommendations 606 generated by recommendation model 559 with the ground truth recommendations 601 included in user interaction data 557 and calculates loss 607. In some embodiments, loss calculation module 519 calculates separate losses included in loss 607 for various aspects of the recommendation task, such as one loss to evaluate the accuracy of content genre predictions and one loss for evaluating the ranking of recommended content items based on user engagement likelihood. The losses can then be aggregated into a composite loss 607 that balances various objectives, such as relevance, diversity, and engagement prediction accuracy. In various embodiments, loss calculation module 519 uses loss functions tailored to specific business objectives to generate loss 607.

At step 917, model trainer 514 updates recommendation model 559 based on loss 607. In various embodiments, model trainer 514 optimizes the parameters of recommendation model 559 through iterative training cycles using optimization algorithms such as Adam, SGD, RMSProp, and/or the like. During each training iteration, model trainer 514 processes loss 607 and updates the parameters of recommendation model 559 to minimize loss 607. In some embodiments, model trainer 514 includes techniques, such as cross-validation and/or the like, to validate model performance on the validation dataset included in user interaction data 557, ensuring that recommendation model 559 generalizes well to unseen data. In at least one embodiment, model trainer 514 uses hyperparameter optimization, such as tuning the learning rate, batch size, or dropout rate, to further refine the training process and improve model performance. In some embodiments, model trainer 514 performs the training iteratively to focus on various aspects of recommendation model 559, such as first training recommendation model 559 on fixed window samples 603 and then fine-tuning recommendation model 559 using sliding window samples 602. In some embodiments, model trainer 514 uses separate loss functions optimized in sequence, such as first minimizing genre prediction loss and then optimizing ranking loss for recommended items.

At step 918, model trainer 514 checks whether to continue training. In some embodiments, model trainer 514 uses early stopping to halt training when performance on the validation dataset stops improving, preventing overfitting. In various embodiments, model trainer 514 trains recommendation model 559 iteratively until a stopping criterion is met, such as reaching a maximum number of iterations, a plateauing loss function, and/or the like. If a stopping criterion is met, method 900 proceeds to step 919. If a stopping criterion is not met, method 900 proceeds to step 911.

At step 919, model trainer 514 stores recommendation model 559. In various embodiments, model trainer 514 stores recommendation model 559 in data store 520, or elsewhere.

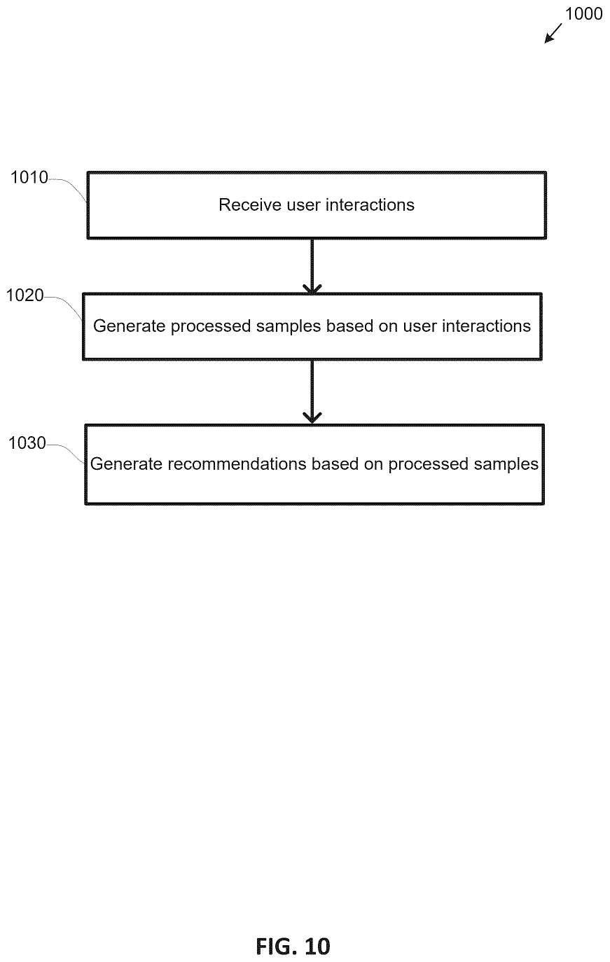

FIG. 10 sets forth a flow diagram of method steps for generating recommendations 702, according to various embodiments. Although the method steps are described in conjunction with the systems of FIGS. 1-7, persons skilled in the art will understand that any system configured to perform the method steps in any order falls within the scope of the present disclosure.

The method 1000 begins with step 1010, wherein recommendation application 546 receives user interactions 701. In various embodiments, recommendation application 546 receives user interactions 701 through various I/O devices, including but not limited to direct interactions, browsing activity, and implicit feedback, such as engagement duration, skipped items, and/or the like.

At step 1020, data pre-processing module 547 generates processed samples 703 based on user interactions 701. In various embodiments, data pre-processing module 547 maps each user interaction type included in user interactions 701 to a dense vector that encodes the relevance and semantic relationship to other user interaction types. In addition to user interaction types, data pre-processing module 547 generates embeddings based on contextual information included in user interactions 701. In some embodiments, data pre-processing module 547 generates processed samples 703, which include embeddings for aggregated behaviors and metadata.

At step 1030, recommendation application 546 generates recommendations 702 based on processed samples 703. In various embodiments, recommendation application 546 uses recommendation model 559 trained using method 900 to process one or more processed samples 703 and generate one or more recommendations 702.

In sum, techniques are disclosed to train recommendation models based on sliding windows. The disclosed techniques include using a sliding window to process user interaction data, where portions of a user's interaction history included in user interaction data are iteratively selected across training epochs. In various embodiments, the sliding window is combined with a fixed window to provide hybrid training that balances short-term and long-term user behavior during the training of the recommendation model. The disclosed techniques allow the recommendation model to incorporate both recent and historical interactions without increasing the input sequence length or model size. Once the recommendation model is trained, the trained recommendation model can be used to generate personalized recommendations based on user interactions.

At least one technical advantage of the disclosed techniques relative to prior art is that the disclosed techniques capture both short-term and long-term user preferences. Unlike conventional approaches that are based exclusively on a fixed window of recent user interactions, the disclosed techniques train a model using a broader range of user interactions resulting in a better trained model. Another technical advantage of the disclosed techniques is the ability to include long-term user preferences without increasing model size, computational cost, or inference latency. These technical advantages represent one or more technological improvements over prior art approaches.

1. In some embodiments, a computer-implemented method for training a machine learning model to generate one or more first recommendations comprises generating, based on user interaction data, a plurality of fixed window samples, generating, based on the user interaction data, a plurality of sliding window samples, and performing, based on the one or more fixed window samples and the one or more sliding window samples, one or more training operations to generate a trained machine learning model to generate the one or more first recommendations.

2. The method of clause 1, wherein the user interaction data comprises one or more user interaction sequences from a plurality of users.

3. The method of clauses 1 or 2, wherein generating the plurality of fixed window samples comprises selecting, from a first user interaction sequence in the user interaction data, a fixed number of most recent user interactions to form a first fixed window sample of the plurality of fixed window samples.

4. The method of any of clauses 1-3, wherein generating the plurality of sliding window samples comprises selecting, from a first user interaction sequence in the user interaction data, a fixed number of contiguous user interactions to form a first sliding window sample of the plurality of sliding window samples.

5. The method of any of clauses 1-4, wherein selecting the fixed number of contiguous user interactions comprises prioritizing based on at least one of user interactions associated with one or more specific time periods, one or more user interactions associated with high-engagement, one or more user interactions associated with one or more user intents, or one or more user interactions associated with one or more business objectives, or one or more user interactions associated with one or more recommendation tasks.

6. The method of any of clauses 1-5, wherein the plurality of sliding window samples comprises a first sliding window sample and a second sliding window sample that has a first overlap with the first sliding window sample.

7. The method of any of clauses 1-6, wherein the plurality of sliding window samples comprises a third sliding window sample that has a second overlap with the first sliding window sample that is different from the first overlap.

8. The method of any of clauses 1-7, wherein performing the one or more training operations further comprises generating, based on the plurality of fixed window samples and the plurality of sliding window samples, one or more hybrid samples, generating, based on the one or more hybrid samples, one or more processed samples, generating, based on the one or more processed samples, one or more second recommendations, computing, based on the one or more second recommendations a loss, and updating, based on the loss, one or more parameters of the machine learning model.

9. The method of any of clauses 1-8, wherein generating the one or more hybrid samples comprises combining a first predefined number of the plurality of fixed window samples and a second predefined number of the plurality sliding window samples.

10. The method of any of clauses 1-9, wherein generating the one or more processed samples comprises generating, based on the one or more hybrid samples, one or more tokens, and generating, based on the one or more tokens, one or more dense vector representations using an embedding table.

11. The method of any of clauses 1-10, wherein the loss is a cross-entropy loss.

12. The method of any of clauses 1-11, wherein performing the one or more training operations comprises alternating between a first number of training epochs using the plurality of fixed window samples and a second number of training epochs using the plurality of sliding window samples.

13. In some embodiments, one or more non-transitory computer-readable media store instructions that, when executed by one or more processors, cause the one or more processors to perform a method comprising generating, based on user interaction data, a plurality of fixed window samples, generating, based on the user interaction data, a plurality of sliding window samples, and performing, based on the one or more fixed window samples and the one or more sliding window samples, one or more training operations to generate a trained machine learning model to generate one or more first recommendations.

14. The one or more non-transitory computer readable media of clause 13, wherein generating the plurality of fixed window samples comprises selecting, from a first user interaction sequence in the user interaction data, a fixed number of most recent user interactions to form a first fixed window sample of the plurality of fixed window samples.

15. The one or more non-transitory computer readable media of clauses 13 or 14, wherein generating the plurality of sliding window samples comprises selecting, from a first user interaction sequence in the user interaction data, a fixed number of contiguous user interactions to form a first sliding window sample of the plurality of sliding window samples.

16. The one or more non-transitory computer readable media of any of clauses 13-15, wherein the plurality of sliding window samples comprises a first sliding window sample and a second sliding window sample that has a first overlap with the first sliding window sample.

17. The one or more non-transitory computer readable media of any of clauses 13-16, wherein performing the one or more training operations further comprises generating, based on the plurality of fixed window samples and the plurality of sliding window samples, one or more hybrid samples, generating, based on the one or more hybrid samples, one or more processed samples, generating, based on the one or more processed samples, one or more second recommendations, computing, based on the one or more second recommendations a loss, and updating, based on the loss, one or more parameters of the machine learning model.

18. The one or more non-transitory computer readable media of any of clauses 13-17, wherein the machine learning model is at least one of a foundation model, an autoregressive model, or a deep neural network.

19. The one or more non-transitory computer readable media of any of clauses 13-18, wherein a size of a first user interaction sequence in the user interaction data is greater than an input size of the machine learning model.

20. In some embodiments, a system comprises one or more memories storing instructions, and one or more processors that are coupled to the one or more memories and, when executing the instructions, are configured to generate, based on user interaction data, a plurality of fixed window samples, generate, based on the user interaction data, a plurality of sliding window samples, and perform, based on the one or more fixed window samples and the one or more sliding window samples, one or more training operations to generate a trained machine learning model to generate one or more recommendations.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a machine learning model to generate one or more first recommendations, the method comprising:
generating, based on user interaction data, a plurality of fixed window samples;
generating, based on the user interaction data, a plurality of sliding window samples; and
performing, based on the one or more fixed window samples and the one or more sliding window samples, one or more training operations to generate a trained machine learning model to generate the one or more first recommendations.

2. The method of claim 1, wherein the user interaction data comprises one or more user interaction sequences from a plurality of users.

3. The method of claim 1, wherein generating the plurality of fixed window samples comprises selecting, from a first user interaction sequence in the user interaction data, a fixed number of most recent user interactions to form a first fixed window sample of the plurality of fixed window samples.

4. The method of claim 1, wherein generating the plurality of sliding window samples comprises selecting, from a first user interaction sequence in the user interaction data, a fixed number of contiguous user interactions to form a first sliding window sample of the plurality of sliding window samples.

5. The method of claim 4, wherein selecting the fixed number of contiguous user interactions comprises prioritizing based on at least one of user interactions associated with one or more specific time periods, one or more user interactions associated with high-engagement, one or more user interactions associated with one or more user intents, or one or more user interactions associated with one or more business objectives, or one or more user interactions associated with one or more recommendation tasks.

6. The method of claim 1, wherein the plurality of sliding window samples comprises a first sliding window sample and a second sliding window sample that has a first overlap with the first sliding window sample.

7. The method of claim 6, wherein the plurality of sliding window samples comprises a third sliding window sample that has a second overlap with the first sliding window sample that is different from the first overlap.

8. The method of claim 1, wherein performing the one or more training operations further comprises:
generating, based on the plurality of fixed window samples and the plurality of sliding window samples, one or more hybrid samples;
generating, based on the one or more hybrid samples, one or more processed samples;
generating, based on the one or more processed samples, one or more second recommendations;
computing, based on the one or more second recommendations a loss; and
updating, based on the loss, one or more parameters of the machine learning model.

9. The method of claim 8, wherein generating the one or more hybrid samples comprises combining a first predefined number of the plurality of fixed window samples and a second predefined number of the plurality sliding window samples.

10. The method of claim 8, wherein generating the one or more processed samples comprises:
generating, based on the one or more hybrid samples, one or more tokens; and
generating, based on the one or more tokens, one or more dense vector representations using an embedding table.

11. The method of claim 8, wherein the loss is a cross-entropy loss.

12. The method of claim 1, wherein performing the one or more training operations comprises alternating between a first number of training epochs using the plurality of fixed window samples and a second number of training epochs using the plurality of sliding window samples.

13. One or more non-transitory computer-readable media storing instructions that, when executed by one or more processors, cause the one or more processors to perform a method comprising:
generating, based on user interaction data, a plurality of fixed window samples;
generating, based on the user interaction data, a plurality of sliding window samples; and
performing, based on the one or more fixed window samples and the one or more sliding window samples, one or more training operations to generate a trained machine learning model to generate one or more first recommendations.

14. The one or more non-transitory computer readable media of claim 13, wherein generating the plurality of fixed window samples comprises selecting, from a first user interaction sequence in the user interaction data, a fixed number of most recent user interactions to form a first fixed window sample of the plurality of fixed window samples.

15. The one or more non-transitory computer readable media of claim 13, wherein generating the plurality of sliding window samples comprises selecting, from a first user interaction sequence in the user interaction data, a fixed number of contiguous user interactions to form a first sliding window sample of the plurality of sliding window samples.

16. The one or more non-transitory computer readable media of claim 13, wherein the plurality of sliding window samples comprises a first sliding window sample and a second sliding window sample that has a first overlap with the first sliding window sample.

17. The one or more non-transitory computer readable media of claim 13, wherein performing the one or more training operations further comprises:
generating, based on the plurality of fixed window samples and the plurality of sliding window samples, one or more hybrid samples;
generating, based on the one or more hybrid samples, one or more processed samples;
generating, based on the one or more processed samples, one or more second recommendations;
computing, based on the one or more second recommendations a loss; and
updating, based on the loss, one or more parameters of the machine learning model.

18. The one or more non-transitory computer readable media of claim 13, wherein the machine learning model is at least one of a foundation model, an autoregressive model, or a deep neural network.

19. The one or more non-transitory computer readable media of claim 13, wherein a size of a first user interaction sequence in the user interaction data is greater than an input size of the machine learning model.

20. A system, comprising:
one or more memories storing instructions; and
one or more processors that are coupled to the one or more memories and,
when executing the instructions, are configured to:
generate, based on user interaction data, a plurality of fixed window samples;
generate, based on the user interaction data, a plurality of sliding window samples; and
perform, based on the one or more fixed window samples and the one or more sliding window samples, one or more training operations to generate a trained machine learning model to generate one or more recommendations.
